(19) United States
(12) Patent Application Publication
(10) Pub. No.: US 2017/0366406 A1
(43) Pub. Date: Dec. 21, 2017

(54) SEALED NETWORK SERVERS

(71) Applicant: Lior Malka, San Jose, CA (US)

(72) Inventor: Lior Malka, San Jose, CA (US)

(21) Appl. No.: 15/186,441

(22) Filed: Jun. 18, 2016

(51) Int. Cl. H04L 12/24; H04L 29/06; H04L 29/08

(52) U.S. Cl. CPC H04L 41/12; H04L 67/1097; H04L 41/0806; H04L 63/0414

(57) ABSTRACT

Embodiments are provided for sealed network servers. A sealed network does not require administrators and may run on hardware and software that has been stripped of privileged capabilities. In one embodiment, a server is added using a root. A root is the first instance of a sealed network. All roots verify that the server identifier is unique, and if so, then a node generates the server using an obfuscator. Any obfuscator may be used. In one embodiment, an application is added to a server in a sealed network. In one embodiment, a method of finding a public application in a sealed network is described.

### BACKGROUND

Existing networks require an administrator. An administrator has privileged capabilities for managing remote devices, such as remote access, software installation, user and passwords modifications, and so on. Networks that require administrators are more expensive and less secure than sealed networks. A sealed network does not require an administrator. However, because a network is sealed, methods are needed so that servers and applications can be added after the sealed network has been initialized.

### SUMMARY

Embodiments are provided for sealed network servers. A sealed network does not require administrators and may run on hardware and software that has been stripped of privileged capabilities. In one embodiment, a server is added by providing input to a root. The root broadcasts a server identifier to all roots, and if the identifier is unique, then a node generates the server using an obfuscator. Any obfuscator may be used. In one embodiment, an application is added to a server in a sealed network. The application may or may not be public. An application is public if other parties can interface with it. In one embodiment, a method of finding a public application in a sealed network is described.

### DRAWINGS

The following figures illustrate the embodiments by way of example. They do not limit their scope.

FIG. 1 shows a flow diagram of a method of adding a server to a sealed network, in accordance with one embodiment.

FIG. 2 shows a flow diagram of a method of adding an application to a server in a sealed network, in accordance with one embodiment.

FIG. 3 shows a flow diagram of a method of finding a public application in a sealed network, in accordance with one embodiment.

### DETAILED DESCRIPTION

This section includes detailed examples, particular embodiments, and specific terminology. These are not meant to limit the scope. They are intended to provide clear and through understanding, cover alternatives, modifications, and equivalents.

A network is a collection of devices. Each device has zero or more parties executing on it. Each party has a unique identifier. A Party may be multithreaded, and each thread may be communicating with other parties using an address. The parties that communicate with a party are the neighbors of that party. Communication channels may be secure or not or both.

A sealed network is a network that does not require administrators. It is guided by an operator using a control panel. Unlike an administrator, an operator does not have privileged capabilities for managing remote devices. A party that provides a control panel is called a root. Inputs provided via the control panel are processed by the root, unless a second root identifier is included, in which case the input is forwarded for processing at the second root. A party for general purpose applications is a server. A party that controls servers is a node. A device may have any number of roots, nodes, and servers. Each party executes applications. An application is public if other parties can interface with it. Otherwise, it is private. A public application may have a service range, which is a range of target identifiers for which the application interface is available. The target identifier may or may not be an identifier of a party.

Parties may run on hardened environments, and may further harden the environment as they execute. Hardening involves configuring or redesigning so that privileged capabilities are eliminated or are inaccessible. All parties may be obfuscated. The obfuscated code is called an instance. An instance is generated by providing randomness and instance inputs to an obfuscator, and compiling the obfuscator output. All instances may have files or databases that are protected, fully or partially, with cryptographic functions, such as encryption, signatures, and signcryption. The description of those functions and their keys may also be protected using a cryptographic function that is obfuscated in the instance.

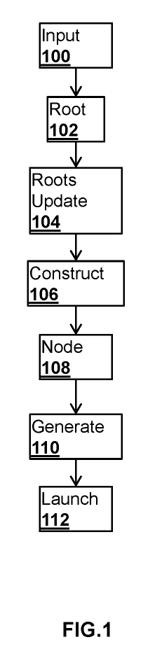

FIG. 1 shows a flow diagram of a method of adding a server to a sealed network, in accordance with one embodiment. The input 100 includes a node identifier, a server identifier, and an address for communicating with other parties. The input is provided to a root 102. The input may or may not originate at the control panel of the root.

The root broadcasts the server identifier to all other roots, who update their tables 104 by adding the server identifier. The update fails if at least one of the roots determines that the server identifier is not unique. Otherwise, the root creates an account that would allow the root and the server to securely communicate. The account, the server identifier, and the address are placed in a construct 106. The construct is sent to the node 108 whose identifier is specified in the input. The node may add data to the construct. For example, the node may create a database account for the server, and add the database credentials. The node may also update its tables. For example, it may add the server identifier, so that the server is restarted after a reboot. The node generates 110 a server instance from the construct, and launches 112 the instance. Any method of obfuscation may be used to generate the instance.

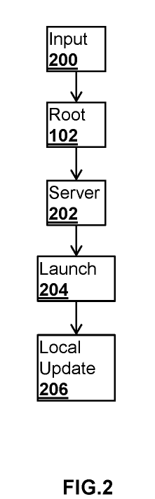

FIG. 2 shows a flow diagram of a method of adding an application to a server in a sealed network, in accordance with one embodiment. The input 200 includes a server identifier, an application identifier, and application parameters. For example, a public application may have a service range as a parameter. The input is provided to a root 102. The input may or may not originate at the control panel of the root.

The root sends the application identifier and application parameters to the server 202 whose identifier is specified in the input. The server launches 204 the application. If the application is public, then the root performs a local update 206 to its tables, associating the server with the application. If the input includes a service range, then the update may also include the service range.

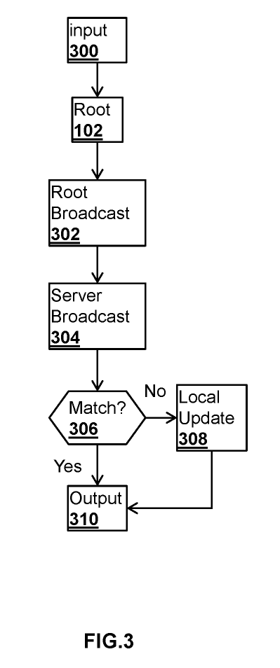

FIG. 3 shows a flow diagram of a method of finding a public application in a sealed network. The input 100 includes an application identifier. If the application has service range, then the input may also include a target identifier. The input is provided to a first root 102. The input may or may not originate at the control panel of the first root.

The first root broadcasts 302 the input to all other roots. Each of the roots in the network performs a server broadcast 304. In a server broadcast, a root sends the input to all neighboring servers that are associated with the application identifier and whose service range contains the target identifier. Each server replies with a match message if the application is available and the target range is within the service range. Otherwise, the server replies with a mismatch message and a mismatch reason. A match message may include additional statistics, such as a load score indicating the load of the application on the server.

If a root receives a match message 306 from a server, then it adds the identifier of the server to a set. Otherwise, it performs a local update 308 to correct the association of the server identifier with the application identifier and the service range. For example, it may remove the association or update the service range. Each root sends its set to the first root. The first root provides the output 310 by computing the union of its own set with the sets received from other roots.

What is claimed is:

1. A method of adding a server to a sealed network, the method comprising:
receiving input including a node identifier, a server identifier, and an address; and
adding the server identifier to all roots, failing if the server identifier is not unique; and
sending a construct containing the server identifier, address, and account for secure communication to the node specified in the input; and
generating a server instance using the construct; and
launching the server.

2. The Method of claim 1, wherein the input is received via a control panel.

3. The Method of claim 1, wherein the input is forwarded to a root for processing.

4. The Method of claim 1, wherein generating a server instance using the construct employs an obfuscator that protects files of the server using a cryptographic function that is obfuscated in the server code.

5. The Method of claim 1, wherein generating a server instance using the construct creates a new database account for the server and the credentials for the database account are added to the construct.

6. The Method of claim 1, wherein launching the server moves data from files of the server to a database account and the files are deleted.

7. A method of adding an application to a server in a sealed network, the method comprising:
providing input including a server identifier, an application identifier, and parameters to a root; and
sending the application identifier and parameters to the server specified in the input to launch the application; and
updating the root to associate the server with the application and parameters, if the application is public.

8. The Method of claim 7, wherein the root receives the input via a control panel.

9. The Method of claim 7, wherein the root receives the input from another root.

10. The method of claim 7, wherein the application parameters include a service range.

11. The method of claim 7, wherein the server replies with an error message if the application is already present.

12. The method of claim 7, wherein the server restarts the application if the application is already present.

13. The method of claim 7, further comprising toggling the application on and off.

14. A method of finding a public application in a sealed network, the method comprising:
receiving input containing an application identifier; and
broadcasting the input to all roots; and
broadcasting the input from each root to neighboring servers who are associated with the application identifier; and
producing, at each root, a set containing the identifiers of all servers replying with a match, and updating the association of servers replying with a mismatch ; and
outputting the union of the sets.

15. The Method of claim 14, wherein the input is received from a control panel.

16. The Method of claim 14, wherein the input is received from a server.

17. The Method of claim 14, wherein the input also includes a target identifier and servers are associated with an application and a service range.

18. The Method of claim 14, wherein the output includes the load score of each server.
